(19) United States
(12) Patent Application Publication
(10) Pub. No.: US 2026/0360085 A1
(43) Pub. Date: Nov. 12, 2026

(54) MESH OPTIMIZING DEVICE

(71) Applicants: HYUNDAI MOTOR COMPANY, Seoul (KR); KIA CORPORATION, Seoul (KR)

(72) Inventors: Hyejun Park, Seoul (KR); Sunjoo Moon, Suwon-si (KR); Wonseok Choi, Seongnam-si (KR)

(73) Assignees: HYUNDAI MOTOR COMPANY, Seoul (KR); KIA CORPORATION, Seoul (KR)

(21) Appl. No.: 19/475,346

(22) PCT Filed: Dec. 14, 2023
(86) PCT No.: PCT/KR2023/020630

§ 371 Date: Oct. 14, 2025

(30) Foreign Application Priority Data
Apr. 14, 2023 (KR) 10-2023-0049217
Jul. 31, 2023 (KR) 10-2023-0099478

(51) Int. Cl. G06T 17/20; G06T 9/00

(52) U.S. Cl. CPC G06T 17/205; G06T 9/001

(57) ABSTRACT

A mesh optimization apparatus may include an input layer that encodes an original mesh into a mesh graph, a graph convolution layer that extracts a characteristic for each vertex by considering a relationship between the each vertex and neighboring vertices of the each vertex in the mesh graph converted by the input layer, a curvature weight layer that calculates curvature information of the converted mesh according to the extracted characteristic and determines a curvature weight according to the curvature information, a pooling layer that down-samples the converted mesh according to the curvature weight corresponding to the each vertex to generate a low-resolution mesh, a decoding layer that reconstructs information of the each vertex in the low-resolution mesh to restore a similar mesh that is similar to the original mesh, and an output layer that generates a final mesh corresponding to the original mesh based on the similar mesh.

### CROSS-REFERENCE TO RELATED APPLICATION

This application claims priority to and the benefit of Korean Patent Application No. 10-2023-0049217 filed with the Korean Intellectual Property Office on Apr. 14, 2023, and Korean Patent Application No. 10-2023-0099478 filed with the Korean Intellectual Property Office on Jul. 31, 2023, the entire contents of which are incorporated herein by reference.

### Technical Field

The present disclosure relates to a mesh optimization apparatus.

### Background Art

In general, 3D modeling data is very large in size. When a certain device uses 3D modeling data, the load imposed on the performance of the device is increased, and the operating speed may be reduced. Due to such high capacity of 3D modeling data, it is difficult to utilize 3D rendering in devices.

### DISCLOSURE

### Technical Problem

The present disclosure aims to provide a mesh optimization apparatus.

### Technical Solution

A mesh optimization apparatus may include: an input layer that encodes an original mesh into a mesh graph; a graph convolution layer that extracts a characteristic for each vertex by considering a relationship between each vertex and neighboring vertices of the vertex in the mesh graph converted by the input layer; a curvature weight layer that calculates curvature information of the converted mesh according to the extracted characteristic and determines a curvature weight according to the curvature information; a pooling layer that down-samples the converted mesh according to the curvature weight corresponding to the each vertex to generate a low-resolution mesh; a decoding layer that reconstructs information of the vertex in the low-resolution mesh to restore a similar mesh that is similar to the original mesh; and an output layer that generates a final mesh corresponding to the original mesh based on the similar mesh.

The input layer may, before encoding the original mesh, perform a first preprocessing of converting the original mesh to be a closed mesh when the original mesh is an open mesh, and a second preprocessing of distinguishing a front side and a back side of the original mesh and converting the original mesh such that a normal direction on the front side of the original mesh faces outward from the original mesh for a location where the normal direction does not face outward from the original mesh.

The input layer may perform data augmentation and division preprocessing on a mesh corresponding to the original mesh to generate training data related to the original mesh. The training data related to the original mesh may be used for machine learning.

The input layer may remove an object unnecessary for 3D modeling when the object unnecessary for the 3D modeling is located inside the original mesh.

The input layer may encode mesh data representing the converted mesh to generate a graph including characteristic information and curvature information of each of a plurality of vertices constituting the converted mesh.

The input layer may classify a region with a high curvature in the converted mesh as a character line, and reduce the number of vertices constituting a region with a low curvature in the converted mesh.

The curvature weight layer may calculate a curvature for each of a plurality of vertices constituting the converted mesh, assign a high curvature weight to a vertex in an important region where the calculated curvature is high, and assign a low curvature weight to a vertex in an unimportant region where the calculated curvature is low.

The decoding layer may perform training to restore the mesh in a direction that minimizes a loss calculated through a loss function that sums a loss value for a character line region, a loss value for a non-character line region, and a total mesh loss value. The loss value for the character line region may correspond to a character line difference between the original mesh and the restored mesh, the loss value for the non-character line region may correspond to a non-character line difference between the original mesh and the restored mesh, and the total mesh loss value may correspond to a vertex difference between the original mesh and the restored mesh.

The decoding layer may calculate the loss value for the character line region by multiplying a distance difference between a character line of the original mesh and a character line of the restored mesh by a weight corresponding to the character line.

The decoding layer may calculate the loss value for the non-character line region by multiplying a distance difference between a non-character line of the original mesh and a non-character line of the restored mesh by a weight corresponding to the non-character line.

The decoding layer may calculate the total mesh loss value by multiplying a difference between the number of vertices of the original mesh and the number of vertices of the restored mesh by a weight corresponding to a mesh loss.

The output layer may generate the final mesh by performing triangulation for each vertex and neighboring vertices of the vertex, with respect to the vertices of the similar mesh.

### Advantageous Effects

The present disclosure provides a mesh optimization apparatus that can optimize a mesh in 3D modeling.

### DESCRIPTION OF THE DRAWINGS

FIG. 1 is a diagram illustrating a mesh optimization apparatus according to some embodiments.

FIG. 2 is a diagram illustrating a configuration of a deep learning processor according to some embodiments.

FIG. 3 is a diagram illustrating a mesh optimization method performed by a deep learning processor according to some embodiments.

FIG. 4 and FIG. 5 are diagrams illustrating a labeling method.

FIG. 6 is a diagram illustrating a curvature distribution of a mesh to describe a mesh normalization method.

FIG. 7 is a diagram for explaining a character line learning method.

FIG. 8 is a flowchart illustrating a training operation and a normal operation of a mesh optimization apparatus.

### MODE FOR INVENTION

The present disclosure relates to a 3D modeling method that allows for the smooth use of 3D rendering in a Web environment. For this, a lightweighting method and apparatus for reducing the size of 3D modeling data are needed. Examples of the 3D modeling method include mesh modeling and non-uniform rational b-splines (NURBS) modeling. Mesh modeling is a method of modeling an object in units of triangles and is widely used in animation, videos, and games. Mesh modeling may be applied to low polygon modeling or high polygon modeling. Low polygon modeling is a modeling method that creates a shape with a minimum number of triangles, and since it uses the minimum number of polygons, the quality is low but the rendering speed is fast. High polygon modeling is a modeling method that creates a shape using a large number of triangles; since it utilizes a large number of polygons, the quality is high but the rendering speed is slow. Software that provides mesh modeling includes Maya, Blender, 3D max, and the like. NURBS modeling is a modeling method that utilizes a NURBS equation, and has high data accuracy (length, distance, curvature, numerical values, etc.). It is mainly used in industrial modeling (automobiles, industrial products, parts) and may be suitable for free-form curve modeling. When performing high-quality surface modeling with NURBS modeling, the rendering speed of the 3D modeling may be slow. Although mesh modeling has relatively lower data accuracy (length, distance, numerical values, etc.) compared to NURBS modeling, it may be a modeling method suitable for the lightweighting of 3D modeling.

Rendering programs such as Web graphics library (WebGL) and game engines render light, environment, materials, and the like by utilizing mesh modeling. It is necessary to implement 3D modeling that matches the desired level of rendering quality. In particular, since most industrial parts are 3D modeled with NURBS modeling, a 3D model that is NURBS-modeled needs to be converted into a mesh. A lot of post-processing is required even after converting a 3D model implemented with NURBS modeling into a mesh.

As the number of vertices of a mesh increases, a computer needs higher specifications to render quickly. For rendering many 3D models on a typical computer specification, the smaller the number of vertices of the 3D modeling, the more advantageous it is for rendering. A plurality of boxes and objects located in a logistics warehouse should be able to be arranged on a 3D screen representing the logistics warehouse. The number of 3D models that can be expressed on one screen is determined by the number of vertices of the 3D modeling. That is, the more the number of vertices of the 3D modeling is minimized, the more objects can be expressed within the 3D screen. Therefore, the smaller the number of vertices of the 3D modeling, the larger the logistics warehouse that can be monitored on one screen.

In implementing a 3D screen on the web, the number of 3D models that can be rendered through WebGL is determined according to the specifications of the computer. It is necessary to minimize the number of vertices to enable the rendering of a plurality of 3D models even on various computer specifications. That is, in order to 3D model a plurality of objects constituting a logistics warehouse, it is necessary to reduce the number of 3D modeling vertices of each object.

3D modeling has different conditions depending on the modeling program, the modeling operator, and the modeling purpose. In order to optimize 3D modeling by considering various conditions, lightweighting of 3D modeling is required. Various methods for providing 3D modeling lightweighting have a disadvantage of taking a long time to lightweight a plurality of 3D objects. If the time for 3D modeling lightweighting can be reduced, the time required to develop a method and apparatus for providing a logistics center as a 3D screen through 3D modeling can be shortened.

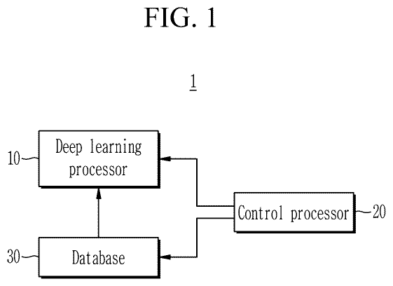

FIG. 1 is a diagram illustrating a mesh optimization apparatus according to some embodiments.

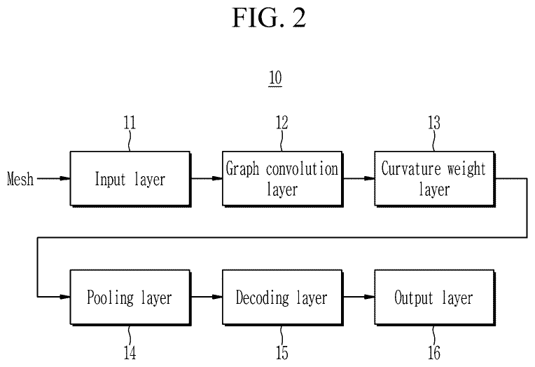

FIG. 2 is a diagram illustrating a configuration of a deep learning processor according to some embodiments.

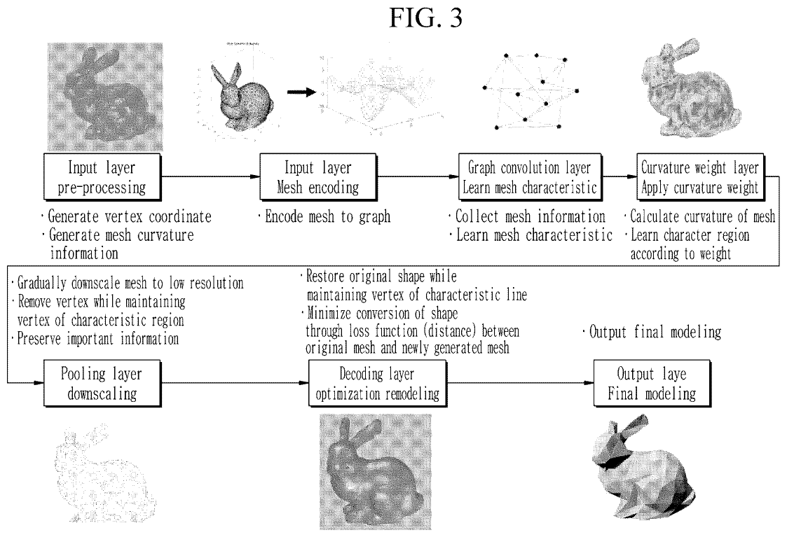

FIG. 3 is a diagram illustrating a mesh optimization method performed by a deep learning processor according to some embodiments.

A mesh processed by a deep learning processor 10 shown in FIG. 3 is a mesh for a 3D rabbit design, which is an example for describing an embodiment.

A mesh optimization apparatus 1 may include a deep learning processor 10, a control processor 20, and a database 30. The deep learning processor 10 is a device that implements a deep learning model, and the control processor 20 may train the deep learning processor 10 with data stored in the database 30, or perform mesh optimization using the deep learning processor 10. The database 30 may store training data necessary for mesh optimization training. In addition, it may store data necessary for the mesh optimization apparatus 1.

The deep learning processor 10 may be a device that implements a neural network according to a deep learning model that implements a deep learning method in software and/or hardware. The deep learning processor 10 may be implemented by one or more of a graphic processing unit (GPU), a neural processing unit (NPU), a tensor processing unit (TPU), or a combination of two or more thereof. The deep learning processor 10 may include a memory such as a DRAM for storing data necessary for operation.

As shown in FIG. 1, the deep learning processor 10 may include an input layer 11, a graph convolution layer 12, a curvature weight layer 13, a pooling layer 14, a decoding layer 15, and an output layer 16.

The input layer 11 may encode a mesh into a graph that may be understood by deep learning. For example, the input layer 11 may encode the mesh into a graph by utilizing the Pytorch Geometric library. The encoded graph may include a matrix (point coordinates, curvature) representing characteristic information of each of a plurality of vertices constituting the mesh.

The input layer 11 may perform a plurality of pre-processings on an original mesh before encoding. When the input original mesh is an open mesh, the input layer 11 may perform a first preprocessing of converting the original mesh to be a closed mesh. The input layer 11 may distinguish a front side and a back side of the original mesh and perform a second preprocessing of converting the original mesh such that a normal direction on the front side of the original mesh faces outward from the original mesh for a location where the normal direction does not face outward from the original mesh. Hereinafter, the first preprocessed original mesh, the second preprocessed original mesh, the first and second preprocessed original mesh, and the original mesh that does not require the first and second preprocessing are collectively referred to as a “mesh”.

The input layer 11 may standardize the direction and size of the mesh by positioning the mesh based on reference coordinates, for example, (0,0,0) in a three-dimensional coordinate system. When an object unnecessary for 3D modeling, such as a certain part or a certain shape, is located inside the original mesh, the input layer 11 may remove the object unnecessary for 3D modeling.

The input layer 11 may perform data augmentation/division preprocessing on the mesh or the original mesh. The mesh or the original mesh is collectively referred to as a mesh corresponding to the original mesh. For example, the input layer 11 may implement data augmentation through data transformation such as rotating the mesh corresponding to the original mesh, adjusting the size of the mesh corresponding to the original mesh, and distorting the shape of the mesh corresponding to the original mesh. In addition, the input layer 11 may divide the mesh corresponding to the original mesh to generate various meshes. Training data related to the original mesh may be generated through data augmentation and division. The deep learning processor 10 may perform machine learning using the training data. Through this, the deep learning processor 10 can improve the mesh recognition rate.

The input layer 11 may encode mesh data representing the mesh to generate a graph including characteristic information and curvature information of each of a plurality of vertices constituting the mesh. The input layer 11 may acquire curvature information for the mesh by utilizing MeshLab and open3D libraries. The input layer 11 may extract an initial characteristic of each of the plurality of vertices constituting the mesh from the mesh. The initial characteristic may include vertex coordinates, a vector of the vertex (direction of a face), and the like. The input layer 11 may set the initial characteristic of each of the plurality of vertices as characteristic information. The input layer 11 may provide the graph derived as a result of encoding to the graph convolution layer 12.

Additionally, the input layer 11 may label lines necessary to form a face in 3D modeling as character lines.

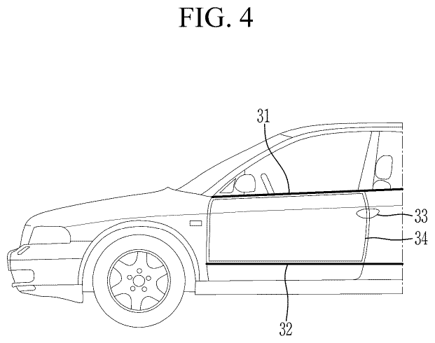

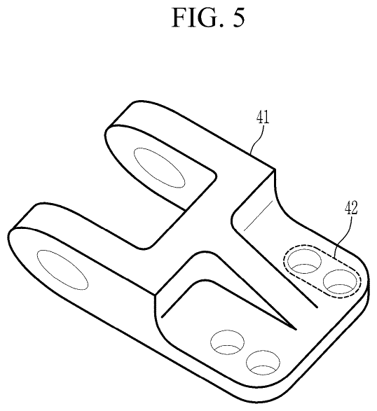

FIG. 4 and FIG. 5 are diagrams illustrating a labeling method.

The input layer 11 may label the lines of the mesh required for 3D modeling of the 3D vehicle design shown in FIG. 4 as character lines. For example, the input layer 11 may label a line 31 and a line 32 in the 3D vehicle design as character lines. Along with labeling, the input layer 11 may mark a removable shape 33 that is unnecessary for 3D modeling, and together mark a face 34 that is not related to a character line. On the face 34, the polygons may have a relatively large size and a uniform shape.

The input layer 11 may label the lines of the mesh required for 3D modeling of the 3D part design shown in FIG. 5 as character lines. For example, the input layer 11 may label a line 41 in the 3D part design as a character line. Along with labeling, the input layer 11 may mark a removable shape 42 that is unnecessary for 3D modeling.

Through such labeling, the learning effect of the deep learning processor 10 may be enhanced, thereby improving the accuracy of 3D modeling.

The input layer 11 may normalize the mesh according to the curvature distribution of the mesh.

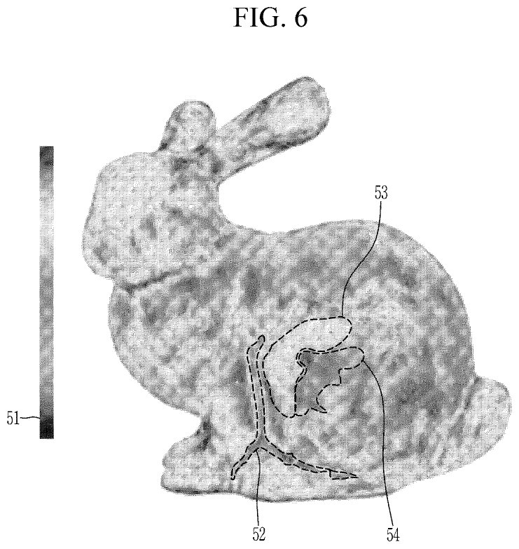

FIG. 6 is a diagram illustrating a curvature distribution of a mesh to explain a mesh normalization method.

The input layer 11 may derive a curvature distribution from a mesh as in FIG. 6. A color bar 51 shows colors according to curvature. In the color bar 51, the direction from bottom to top is a direction in which curvature increases. As the curvature of a certain region of the mesh increases, that region is closer to an edge, and as the curvature of a certain region of the mesh decreases, that region is closer to a plane.

The input layer 11 may classify a region of the mesh with high curvature as a character line. Specifically, the input layer 11 may recognize the curvature of a mesh region (e.g., 52) indicated in red in FIG. 6, and if the recognized curvature is equal to or greater than a predetermined reference value, it may classify the region 52 as a character line. Then, a plurality of vertices constituting the region 52 may be maintained. In FIG. 5, the curvature of the region displayed in yellow and green series may be a region where the mesh curvature is lower than that of the region 52. The input layer 11 may recognize the curvature for a non-red region, such as yellow or green, and if the recognized curvature is less than a predetermined reference value, it may classify the corresponding region as a region with low mesh curvature. The input layer 11 may reduce the number of vertices constituting the region with low mesh curvature by applying a quadric error metrics (QEM) algorithm. The QEM algorithm is one of the mesh simplification methods, but the invention is not limited thereto. In addition to the QEM algorithm, other algorithms that can maintain the original shape while reducing the number of vertices of the mesh may be applied.

The input layer 11 may encode a plurality of vertices constituting the normalized mesh to generate a graph, and may provide the generated graph to the graph convolution layer 12. This graph is hereinafter referred to as a mesh graph.

The graph convolution layer 12 may be implemented as a plurality of graph convolution layers to learn local information about the mesh. The graph convolution layer 12 may learn various characteristics about the mesh using the mesh graph. The graph convolution layer 12 may extract a characteristic for each vertex by considering a relationship between each vertex and its surrounding neighboring vertices, for a plurality of vertices constituting the mesh graph. For example, the graph convolution layer 12 may extract the characteristic for each vertex by convolving each vertex and its surrounding neighboring vertices. The graph convolution layer 12 may learn various patterns and structures on a mesh surface by acquiring local information about the mesh according to the extracted characteristic. The graph convolution layer 12 becomes able to recognize an important region such as a character line of the mesh through learning. The graph convolution layer 12 may transmit the extracted characteristic to the curvature weight layer 13.

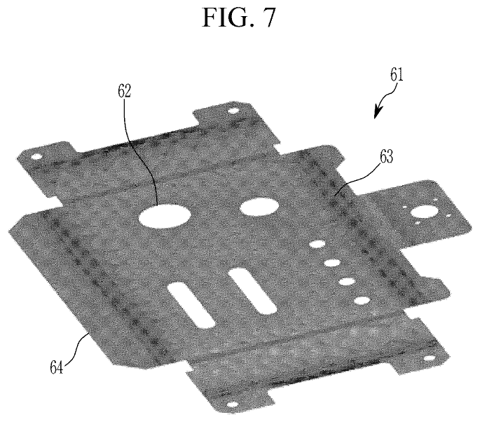

FIG. 7 is a diagram for explaining a character line learning method.

FIG. 7 shows a mesh of a flattened sheet metal part. As shown in FIG. 7, in a training operation, the graph convolution layer 12 may fill a holed portion located within a mesh 61 to form a face, and delete a shape of a certain size or less and then form a face. For example, in the training operation, the graph convolution layer 12 may convert a holed portion like a region 62 into a face. After the above processing, the graph convolution layer 12 may recognize a region 63 with high curvature, classify the region 63 as a character edge, recognize a region 64 representing the shape of the mesh 61, and classify the region 62 as an outline of the mesh 61. Character edges, outlines, and the like are examples of character lines and need to be maintained as design elements.

In the training operation, the graph convolution layer 12 may distinguish between a character line and a non-character region based on mesh curvature information. The graph convolution layer 12 may learn to recognize a character line if the mesh curvature is high and recognize a non-character region if the mesh curvature is low. For example, the graph convolution layer 12 may recognize the region shown in green in FIG. 6 as a non-character region close to a plane, and recognize the region shown in red in FIG. 6 as a character line.

The curvature weight layer 13 may use curvature information to measure the importance of a vertex. The curvature weight layer 13 may calculate the curvature information for each vertex of the mesh using the normal vectors of the surrounding triangles. Curvature is an indicator of how much the surface of the mesh is bent, and the curvature value may appear large in a characteristic part of the mesh, such as a character line. Based on the calculated curvature information, the curvature weight layer 13 may learn to assign a high weight to a vertex in a region of high importance (e.g., high curvature) and assign a low weight to a vertex in a region of relatively low importance (e.g., low curvature), and operate as learned. Hereinafter, a region of high importance is referred to as an important region, a region of low importance is referred to as an unimportant region, and a weight based on the curvature information of each vertex is referred to as a curvature weight. In this way, the curvature weight layer 13 may preserve an important region that is a design element, for example, a character line, by assigning a curvature weight corresponding to the characteristic of each vertex to the curvature of each vertex. Through this, the important region (e.g., character line) in the mesh may be preferentially preserved, and unnecessary vertex may be removed. The curvature weight information acquired by the curvature weight layer 13 is delivered to the pooling layer 14, and thus optimization may proceed in which a vertex of the important region (hereinafter, important vertex) is preserved as much as possible, and a vertex of the unimportant region (hereinafter, unimportant vertex) is removed.

The pooling layer 14 may utilize a curvature weight to reduce the number of vertices while preserving an important vertex. The pooling layer 14 may perform down-sampling of the mesh while maintaining the important vertex and removing the unimportant vertex based on the curvature weight of the mesh. As the mesh is down-sampled to a low-resolution mesh by the pooling layer 14, the number of vertices may be reduced and the complexity of the mesh may be decreased. In the down-sampling process by the pooling layer 14, an important vertex is preferentially preserved and an unimportant vertex is removed, and thus important information (a character line, etc.) of the mesh may be preserved. Through this, overfitting can be prevented. For clarity of explanation, hereinafter, the original mesh may mean a mesh before being down-sampled according to the importance of vertices, and the low-resolution mesh may mean a mesh that has been down-sampled by the pooling layer 14 from the original mesh.

The decoding layer 15 may restore a mesh similar to the original mesh (hereinafter, a similar mesh) by reconstructing the vertex information in the low-resolution mesh. The decoding layer 15 may repeatedly restore the low-resolution mesh to generate a mesh with gradually increasing resolution. The decoding layer 15 may perform learning to restore the vertex position information of the original mesh based on the vertex information in the low-resolution mesh. In this case, the decoding layer 15 may learn to restore a character line from the low-resolution mesh and restore the mesh by minimizing the number of mesh vertices.

In the learning process, the loss function of the decoding layer 15 can be determined in a direction that optimizes the number of vertices while minimizing the difference between the original mesh and the decoded mesh. In the learning process, the decoding layer 15 may perform training to restore the mesh in a direction that minimizes a loss calculated through a loss function that sums a loss value for a character line region, a loss value for a non-character line region, and a total mesh loss value. For example, the decoding layer 15 may be trained to further divide a face constituting the mesh as the loss becomes larger. The decoding layer 15 may calculate the loss value for the character line region by multiplying a distance difference between a character line of the original mesh and a character line of the mesh restored in the decoding layer 15 by a weight corresponding to the character line. A larger distance difference indicates that a shape difference between the original mesh and the mesh output by the decoding layer 15 is larger. When the distance difference is large, the decoding layer 15 may restore the mesh in a direction to reduce the distance difference by further dividing the face including the character line. The decoding layer 15 may calculate the loss value for the non-character line region by multiplying a distance difference between a non-character line of the original mesh and a non-character line of the mesh restored in the decoding layer 15 by a weight corresponding to the non-character line. A larger distance difference may mean that the shape difference between the original mesh and the mesh output by the decoding layer 15 is larger. When the distance difference is large, the decoding layer 15 may restore the mesh in a direction to reduce the distance difference by further dividing the face including the non-character line. The decoding layer 15 may calculate the total mesh loss value by calculating a difference between the number of vertices of the original mesh and the number of vertices of the mesh restored by the decoding layer 15, and multiplying the corresponding difference by a weight corresponding to a mesh loss.

The weight corresponding to the character line, the weight corresponding to the non-character line, and the weight corresponding to the mesh loss may be adjusted to strike a balance between the goal of maintaining the character line as much as possible and the goal of minimizing the number of vertices. The three weight values in the loss function may be updated during the learning process. The decoding layer 15 may perform learning in a direction that minimizes the loss function. After learning, the decoding layer 15 may generate a similar mesh by decoding the low-resolution mesh.

The output layer 16 may generate a final mesh corresponding to the original mesh based on the vertices of the similar mesh restored by the decoding layer 15. For example, the output layer 16 may generate the final mesh by applying the Delaunay Triangulation algorithm to the vertices of the similar mesh. Delaunay Triangulation is an algorithm for triangulating between points, and the output layer 16 may generate the final mesh by performing an operation of generating an optimal triangle considering a relationship between each vertex and its surrounding vertices for all vertices of the similar mesh. The output layer 16 may output the final mesh in a usable file format (OBJ, STL, FBX, Collada (DAE)). Then, the lightweighted 3D model may be used in other programs (e.g., Unreal).

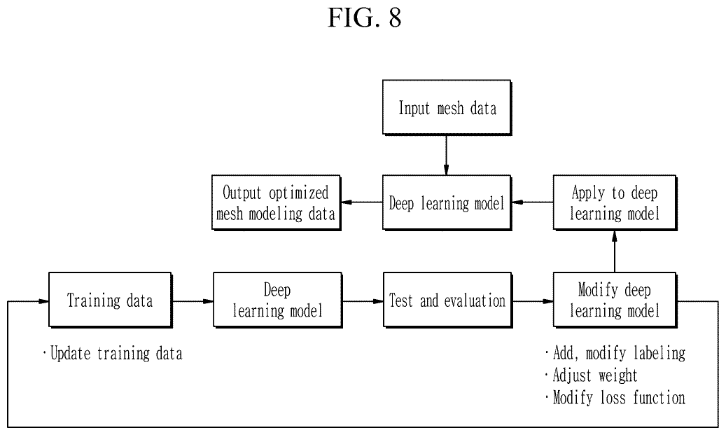

FIG. 8 is a flowchart illustrating a training operation and a normal operation of a mesh optimization apparatus.

As shown in FIG. 8, the training operation may include an operation in which the deep learning apparatus 1 receives training data, and performs training with the training data to set a deep learning model. The training data may be updated. Testing and evaluation of the deep learning model set by the deep learning apparatus 1 through training are performed, and the deep learning model may be modified according to the test and evaluation results. Modifying the deep learning model may include adding labeling to the training data, modifying labeling, adjusting weights, modifying the loss function, and the like. In this way, accuracy and optimization of mesh modeling can be achieved through repetitive and diverse data training.

The deep learning apparatus 1 may update the deep learning model by reflecting the modification of the deep learning model. The deep learning model updated through such training may process input mesh data and output optimized mesh modeling data.

While the embodiments of the present invention have been described in detail above, the scope of the rights of the present invention is not limited thereto, and various modifications and improvements by those skilled in the art using the basic concept of the present invention as defined in the following claims also fall within the scope of the rights of the present invention.

What is claimed is:

1. A mesh optimization apparatus, comprising:
an input layer configured to encode an original mesh into a mesh graph;
a graph convolution layer configured to extract a characteristic for each vertex by considering a relationship between each vertex and neighboring vertices of the vertex in the mesh graph converted by the input layer;
a curvature weight layer configured to calculate curvature information of the converted mesh according to the extracted characteristic and determine a curvature weight according to the curvature information;
a pooling layer configured to down-sample the converted mesh according to the curvature weight corresponding to each vertex to generate a low-resolution mesh;
a decoding layer configured to reconstruct information of each vertex in the low-resolution mesh to restore a similar mesh that is similar to the original mesh; and
an output layer configured to generate a final mesh corresponding to the original mesh based on the similar mesh.

2. The mesh optimization apparatus of claim 1, wherein:
the input layer is configured to perform, before encoding the original mesh,
first preprocessing of converting the original mesh to be a closed mesh when the original mesh is an open mesh, and second preprocessing of distinguishing a front side and a back side of the original mesh and converting the original mesh such that a normal direction on the front side of the original mesh faces outward from the original mesh for a location where the normal direction does not face outward from the original mesh.

3. The mesh optimization apparatus of claim 2, wherein:
the input layer is configured to perform data augmentation and division preprocessing on a mesh corresponding to the original mesh to generate training data related to the original mesh, and
the training data related to the original mesh is used for machine learning.

4. The mesh optimization apparatus of claim 1, wherein:
the input layer is configured to remove an object unnecessary for 3D modeling when the object unnecessary for the 3D modeling is located inside the original mesh.

5. The mesh optimization apparatus of claim 1, wherein:
the input layer is configured to encode mesh data representing the converted mesh to generate a graph including characteristic information and curvature information of each of a plurality of vertices constituting the converted mesh.

6. The mesh optimization apparatus of claim 5, wherein:
the input layer is configured to classify a region with a high curvature in the converted mesh as a character line, and reduce a number of vertices constituting a region with a low curvature in the converted mesh.

7. The mesh optimization apparatus of claim 1, wherein:
the curvature weight layer is configured to calculate a curvature for each of a plurality of vertices constituting the converted mesh, assign a high curvature weight to a vertex in an important region where the calculated curvature is high, and assign a low curvature weight to a vertex in an unimportant region where the calculated curvature is low.

8. The mesh optimization apparatus of claim 1, wherein:
the decoding layer is configured to perform training to restore a mesh in a direction that minimizes a loss calculated through a loss function that sums a loss value for a character line region, a loss value for a non-character line region, and a total mesh loss value,
the loss value for the character line region corresponds to a character line difference between the original mesh and the restored mesh,
the loss value for the non-character line region corresponds to a non-character line difference between the original mesh and the restored mesh, and,
the total mesh loss value corresponds to a vertex difference between the original mesh and the restored mesh.

9. The mesh optimization apparatus of claim 8, wherein:
the decoding layer is configured to calculate the loss value for the character line region by multiplying a distance difference between a character line of the original mesh and a character line of the restored mesh by a weight corresponding to the character line.

10. The mesh optimization apparatus of claim 8, wherein:
the decoding layer is configured to calculate the loss value for the non-character line region by multiplying a distance difference between a non-character line of the original mesh and a non-character line of the restored mesh by a weight corresponding to the non-character line.

11. The mesh optimization apparatus of claim 8, wherein:
the decoding layer is configured to calculate the total mesh loss value by multiplying a difference between a number of vertices of the original mesh and a number of vertices of the restored mesh by a weight corresponding to a mesh loss.

12. The mesh optimization apparatus of claim 1, wherein:
the output layer is configured to generate the final mesh by performing triangulation for each vertex and neighboring vertices of the vertex, with respect to vertices of the similar mesh.
